(19) United States
(12) Patent Application Publication
(10) Pub. No.: US 2007/0194903 A1
(43) Pub. Date: Aug. 23, 2007

(54) Vehicle turn signals

(76) Inventor: Eugene Walasik, Ocala, FL (US)

Correspondence Address: ALUN L. PALMER, PATENT AGENT, 4300 PINEY CHURCH ROAD, WALDORF, MD, 20602, US

(21) Appl. No.: 11/359,390

(22) Filed: Feb. 23, 2006

(51) Int. Cl. B60Q 1/34

(52) U.S. Cl. 340/465; 340/475

(57) ABSTRACT

Sun visors, cab fairings and wings or spoilers mounted on top of cabs, or in rear areas of vehicles are provided with sequencing lights, that is to say power is fed selectively to either a left or right bank of signal indicator lights depending on the direction that the vehicle driver wishes to turn, where each bank is composed of plural lights, such that when a bank of lights is electrically activated the lights are each illuminated in turn beginning with the centermost light and then each adjoining light is sequentially powered, so that the lights appear to travel in the direction the driver is signaling to turn.

### BACKGROUND OF THE INVENTION

1. Field of the Invention

The invention relates to turn signals for vehicles. More particularly, the invention relates to turn signals having a ‘moving’ array of lights on a spoiler or in another raised position.

2. Discussion of the Background

A very high proportion of traffic accidents occur at intersections. One cause of such accidents is the failure to see turn signals. One arrangement that has been employed to make turn signals more visible is to use moving arrays of indicator lights, such as for example in the 1968 Cougar.

This invention solves this and other problems, as will be more fully explained with reference to the several views, in which like numerals refer to like elements.

### SUMMARY

The present invention provides for mounting turn signals or indicator lights in an elevated position so as to enhance their visibility.

In particular, the invention pertains to sun visors, cab fairings and wings or spoilers mounted either on top of cabs or in rear areas of vehicles. According to a preferred embodiment of the invention these are provided with sequencing lights, that is to say power is fed selectively to either a left or right bank of signal indicator lights depending on the direction that the vehicle driver wishes to turn, where each bank is composed of plural lights, such that when a bank of lights is electrically activated the lights are each illuminated in turn beginning with the centermost light and then each adjoining light is sequentially powered, so that the lights appear to travel in the direction the driver is signaling to turn.

### BRIEF DESCRIPTION OF THE DRAWINGS

FIG. 1 is an exploded view of a truck showing a visor according to a preferred embodiment of the invention.

FIG. 2 is an exploded view of a truck showing a cab fairing according to a preferred embodiment of the invention.

FIG. 3 is a view of an automobile showing a rear spoiler according to a preferred embodiment of the invention.

FIG. 4 is a block diagram of a system according to a preferred embodiment of the present invention.

FIG. 5 is a schematic of a circuit according to a preferred embodiment of the invention.

FIG. 6 shows a rear spoiler lighting kit according to a preferred embodiment of the invention.

### DETAILED DESCRIPTION

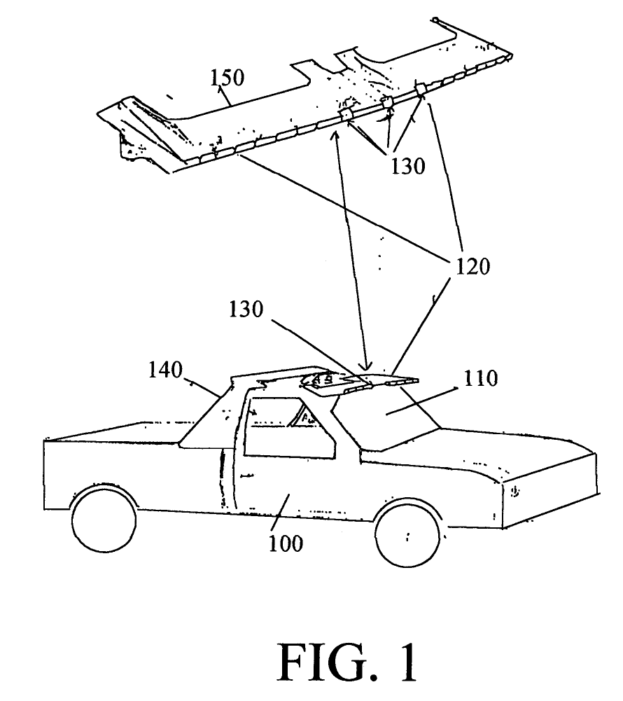

FIG. 1 shows a truck 100 with a sun visor 150 according to a preferred embodiment of the invention. Truck 100 is provided windshield 110 and rear window 140 and has a sun visor 150 mounted above windshield 110. Mounted on sun visor 150 are indicator lights 120 and parking lights 130. The indicator lights 120 are preferably energised sequentially to produce a ‘moving light’ effect.

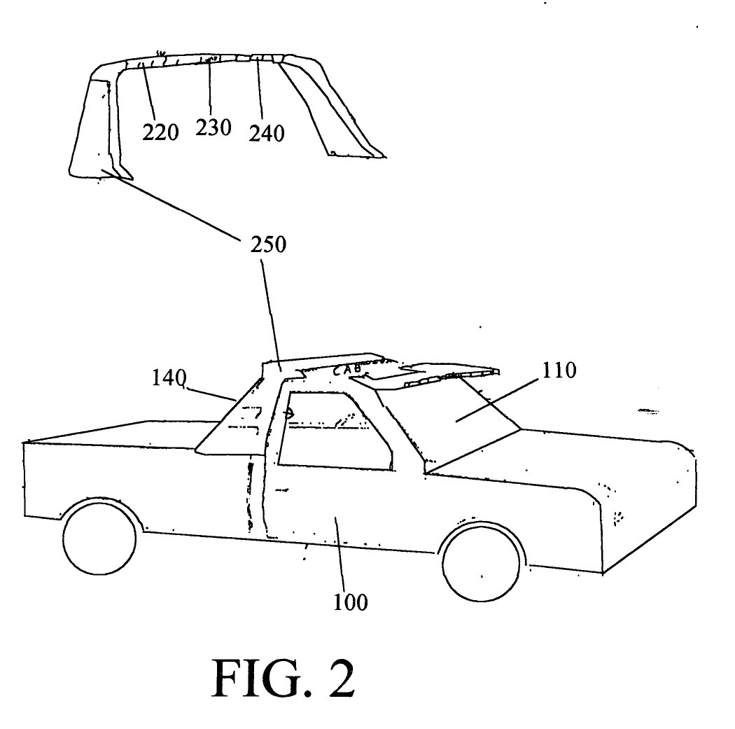

FIG. 2 shows the truck 100 with a cab fairing 250 according to a preferred embodiment of the invention. Cab fairing 250 is shown mounted immediately in front of rear window 140 in this example, and is provided with indicator lights 220 and parking lights 230. As in the case of the sun visor 150, the indicator lights 220 are preferably energised sequentially to produce a ‘moving light’ effect.

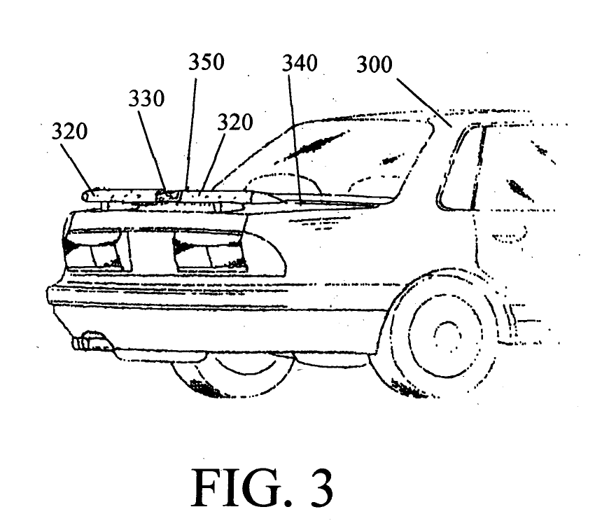

FIG. 3 shows an automobile 300 with a rear spoiler 350 according to a preferred embodiment of the invention. Spoiler 350 is shown mounted on trunk 340, and is provided with indicator lights 320 and parking lights 330. As in the previous embodiments, the indicator lights 320 are preferably energised sequentially to produce a ‘moving light’ effect.

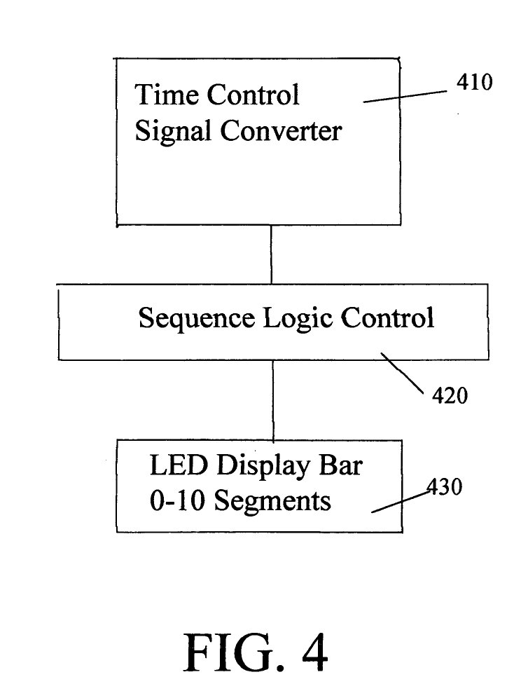

FIG. 4 shows a block diagram of an embodiment according to the invention, showing a time control speed convertor 410 connected to a sequence logic control 420, in turn connected to a display 430, which may be a horizontal bar of LEDs., or other row of illuminating devices.

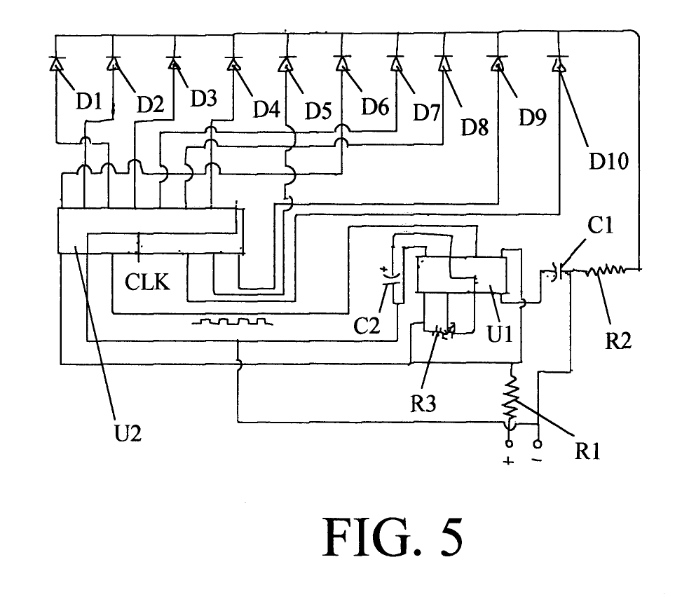

FIG. 5 shows an exemplary schematic of a circuit according to preferred embodiment of the invention. U1 is a timer integrated circuit, such as the well known 555 timer, and U2 is, for example, a 4017 integrated circuit. Diodes D1-D10 are light emitting diodes, although it will be appreciated by those skilled in the art that other light sources could be used without departing from the scope of the invention. C1 and C2 are capacitors and R1-R3 are resistors. These capacitors and resistors are required for the proper operation of U1. With reference to FIG. 4, U1 fulfills the function of the time control speed convertor 410 and U2 fulfills the function of the sequence logic control 420.

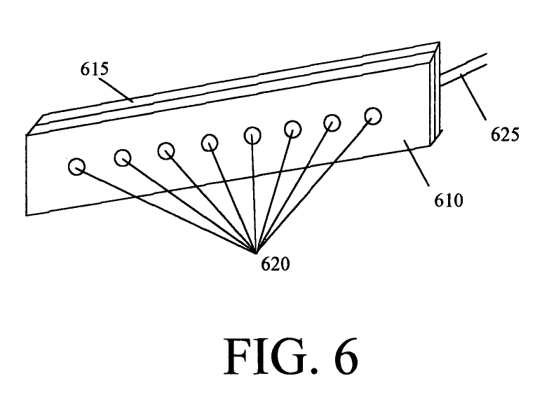

FIG. 6 shows a rear spoiler lighting kit according to a preferred embodiment of the invention. In this example a light diffusing board 610 is mounted on a light mounting board 615 carrying a plurality of indicator lights 620 and provided with a cable harness 625. Light diffusing board 610 may be in the form of an elongated rectangular red lens, for example, and indicator lights 620 may be LEDs, although other arrangements are possible without departing from the scope of the invention.

As will readily be appreciated by those skilled in the art, numerous modifications and variations of the above embodiments of the present invention are possible without departing from the scope of the invention.

What is desired to be claimed in Letters Patent is:

1. A vehicle turn signal, comprising:
an array of lights for indicating a turn direction of said vehicle,
said array mounted substantially above a set of running lights of said vehicle,
said array comprising a first end and a second end,
each of said lights successively operated beginning at said first end and continuing until said second end.

2. The vehicle turn signal according to claim 1, wherein:
operating each of said lights comprises illuminating said light.

3. The vehicle turn signal according to claim 2, wherein:
each of said lights is illuminated when at least one previously illuminated light is extinguished.

4. The vehicle turn signal according to claim 2, wherein:
operating each of said lights comprises extinguishing said light after illuminating said light.

5. The vehicle turn signal according to claim 4, wherein:
each of said lights is illuminated when at least one previously illuminated light is extinguished.

6. The vehicle turn signal according to claim 1, wherein:
said vehicle is provided with a rear spoiler;
said indicator lights mounted on said spoiler.

7. The vehicle turn signal according to claim 1, wherein:
said vehicle is provided with a cab fairing;
said indicator lights mounted on cab fairing.

8. The vehicle turn signal according to claim 1, wherein:
said vehicle is provided with a sun visor;
said indicator lights mounted on said sun visor.

9. A vehicle turn signal, wherein:
said array is mounted substantially above a set of running lights of said vehicle
